(19) United States
(12) Patent Application Publication
(10) Pub. No.: US 2010/0007773 A1
(43) Pub. Date: Jan. 14, 2010

(54) Video Processing and Telepresence System and Method

(76) Inventors: Ian O'Connell, London (GB); Alex Howes, London (GB)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/464,224

(22) Filed: May 12, 2009

Related U.S. Application Data
(60) Provisional application No. 61/080,411, filed on Jul. 14, 2008.

(30) Foreign Application Priority Data
Mar. 27, 2009 (GB) 0905317.4

(51) Int. Cl. H04N 5/262; H04N 7/26; H04N 5/14; H04N 9/74

(52) U.S. Cl. 348/239; 375/240.01; 348/571; 348/578; 348/E05.031; 348/E05.062

(57) ABSTRACT

A codec having a video input for receiving a continuous video stream, an encoder for encoding the continuous video stream to result in an encoded video stream, a video output for transmitting the encoded video stream, and switching means for switching the encoder during encoding between a first mode, in which the continuous video stream is encoded in accordance with a first encoding format, to a second mode, in which the continuous video stream is encoded in accordance with a second encoding format.

This invention relates to video processing and, in particular, but not exclusively, a video codec and video processor for use in a telepresence system for generating a “real-time” Pepper's Ghost and/or an image of a subject isolated (keyed out) from the background in front of which the subject was filmed (hereinafter referred to as an “isolated subject image”).

In a conventional telepresence system, a video image of a subject complete within its background captured at one location is transmitted, for example over the Internet or a multi-protocol label switching (MPLS) network, to a remote location where the image of the subject and background is projected as a Pepper's Ghost or otherwise displayed. The transmission may be carried out such that a “real-time” or at least pseudo real-time image can be generated at the remote location to give the subject a “telepresence” at that remote location. The transmission of the video typically involves the use of a preset codec for encoding and/or decoding the video at each of the transmitting and receiving ends of the system.

Typically, a codec includes software for encrypting and compressing the video (including the audio) stream into data packets for transmission. The method of encoding comprises receiving the video stream and encoding the video stream into one of an interlaced or progressive signal (and may also comprise a compression technique).

It has been found that a Pepper's Ghost or isolated subject image of a substantially stationary subject generated from a progressive video signal results in a clear, detailed image. However, at the equivalent frames per second (fps) progressive signals are twice the size of interlaced signals and, in a telepresence system where the video image is captured at one location and transmitted to another over a communication line of finite bandwidth, transmission of large progressive signals can result in latency/inconsistencies that produce undesirable artefacts in the projected “real-time” image. For example, if a subject of the video is moving, the isolated subject or Pepper's Ghost may not appear fluid, the latency may result in a perceivable delay in the interaction of the subject of the isolated subject or Pepper's Ghost with a real person or a bottleneck in a communication line may result in a temporary blank frame of the video and/or missing audio. This reduces the realism of the telepresence of the subject.

It may be possible to reduce such signal delay by compressing the video stream or by encoding using interlaced video signals. Generally, a raw BP standard definition (SD) stream is 270 m/bits per second and can be compressed to 1.5 to 2 m/bits per second, 720P to between 2 to 3 m/bits per second and 1080P to between 4 and 10 m/bits per second. However, compression of a video stream results in certain elements of the original data's integrity being lost or in some way degraded. For example, compression of an HD video stream typically causes dilution of image colour saturation, reduced contrast and introduces the appearance of motion blur around the body of the subject due to apparent or perceived loss of lens focus. This apparent softening of the image is most evident on areas of detail where the image darkens, such as eye sockets, in circumstances where the subject matter moves suddenly or swiftly left or right and where the video image has high contrast.

Interlaced video signals may be used to reduce signal latency, as they use half the bandwidth of progressive signals at the same fps, whilst retaining the appearance of fluid movement of the isolated subject or Pepper's Ghost. However, the interlaced switching effect between odd and even lines of the interlaced video signals reduces quality of the vertical resolution of the image. This can be compensated for by blurring (anti-aliasing) the image, however such anti-aliasing comes at a cost to image clarity.

An advantage of interlaced signals over progressive signals is that the motion in the image generated from interlaced signals appears smoother than motion in an image generated from progressive signals because interlaced signals use two fields per frame. Isolated subject images or Pepper's Ghosts generated using progressive video signals can look flatter and therefore less realistic than images generated using interlaced video signals due to the reduced motion capture and the fact that full frames of the video are progressively displayed. However, text and graphics, particularly static graphics, can benefit from being generated using a progressive video signal as images generated from progressive signals have smoother, sharper outline edges for static images.

Accordingly, whichever type of encoding format the codec is preset to use, there is potential for undesirable effects to occur in the resultant isolated subject or Pepper's Ghost. This is a particular problem for the generation of a telepresence at public/large events wherein the action being filmed, for example the action on a stage, and the system requirements can change significantly throughout the production.

For certain telepresence systems (called hereinafter “immersive telepresence systems”) a video image of a subject keyed out from the background of an image (an isolated subject image) captured at one location is sent to a remote location where the keyed out image is displayed as an isolated subject image and/or Pepper's Ghost, possibly next to a real subject at the remote location. This can be used to create the illusion that the subject of the keyed out image is actually present at the remote location. However, the compression and transmission of the keyed out image gives rise to certain problems because the keying out of the subject forms an isolated subject image wherein the area of the image that is not the subject comprises black, ideally in its purest form (i.e. not grey). However, the processing and transmission of the isolated subject image can contaminate the black area of the image with erroneous video signals, resulting in artefacts such as speckling, low luminosity and coloured interference, that dilute the immersive telepresence experience.

According to the first aspect of the invention there is provided a codec comprising a video input for receiving a continuous video stream, an encoder for encoding the video stream to result in an encoded video stream, a video output for transmitting the encoded video stream and switching means for switching the encoder during encoding of the video stream between a first mode, in which the video stream is encoded in accordance with a first encoding format, to a second mode, in which the video stream is encoded in accordance with a second encoding format.

According to a second aspect of the invention there is provided a codec comprising a video input for receiving an encoded video stream, a decoder for decoding the encoded video stream to result in a decoded video stream, a video output for transmitting the decoded video stream and switching means for switching the decoder during decoding of the encoded video stream between a first mode, in which the encoded video stream is decoded in accordance with a first encoding format, to a second mode, in which the encoded video stream is decoded in accordance with a second encoding format.

An advantage of the invention is that the codec can be switched midstream to encode the video stream in a different format as is appropriate based on footage being filmed, the network capability, for example available bandwidth, and/or other external factors. The switching means may be responsive to an external control signal for switching the encoder/decoder between the first mode and the second mode. For example, the external control signal may be generated automatically on detection of a particular condition or by a user such as a presenter, artist or other controller, for example, by the user operating a button/switch.

The codec may be arranged to transmit and receive control messages to/from a corresponding codec from which it receives/to which it transmits the encoded video stream, the control messages including an indication of the encoding format in which the video stream is encoded. The codec may be arranged to switch between modes in response to received control messages.

The encoding format may be encoding the video signal as a progressive, e.g. 720p, 1080p, or interlaced, e.g. 1080i, video signal, encoding the video stream at a particular frame rate, e.g. from 24 to 120 frames per second, and/or compression of the video signal, for example encoding according to a particular colour compression standard, such as 3:1:1, 4:2:0, 4:2:2 or 4:4:4 or encoding to achieve a particular input/output data rate, such as between 1.5 to 4 megabits/second.. Accordingly, the codec may switch between a progressive and interlaced signal, different frame rates and/or compression standards, as appropriate.

It will be understood that variable bit rate formats, such as MPEG, are a single encoding format within the meaning of the term as used herein. According to a third aspect of the invention there is provided a telepresence system comprising a camera for filming a subject to be displayed as an isolated subject or/and Pepper's Ghost, a first codec according to the first aspect of the invention for receiving a video stream generated by the camera and outputting an encoded video stream, means for transmitting the encoded video stream to a second codec according to the second aspect of the invention at a remote location, the second codec arranged to decode the encoded video signal and output a decoded video signal to apparatus for producing the isolated subject image and/or Pepper's Ghost based on the decoded video signal, and a user operated switch arranged to generate a control signal to cause the first codec to switch between the first mode and the second mode.

Such a system allows an operator, for example a director, presenter, artist, etc to control the method of encoding based on the action being filmed. For example, if there is little movement of the subject then the operator may select a format that provides a progressive signal with little or no compression whereas of there is significant movement of the subject, the operator may select a format that provides an interlaced signal with, optionally, high compression.

The user operated switch may be further arranged to generate a control signal to cause the second codec to switch between the first mode and the second mode. Alternatively, the second codec may be arranged to automatically determine an encoding format of the encoded video stream and switch to decode the encoded video stream using the correct (first or second) mode.

According to a fourth aspect of the invention there is provided a method of generating a telepresence of a subject comprising filming the subject to generate a continuous video stream, transmitting the video stream to a remote location and producing an isolated image and/or a Pepper's Ghost at the remote location based on the transmitted video stream, wherein transmitting the video stream comprises selecting different ones of a plurality of encoding formats during the transmission of the video stream based on changes in action being filmed and changing the encoding format to the selected encoding format during transmission.

The changes in action being filmed may be movement of the subject, an additional subject entering the video frame, changes in lighting of the subject, changes in the level of interaction of the filmed subject with a person at the remote location, inclusion of text or graphics or other suitable changes in the action being filmed/formed into a video.

According to a fifth aspect of the invention there is provided a telepresence system comprising a camera for filming a subject to be displayed as an isolated image and/or Pepper's Ghost, and a communication line for transmitting the encoded video stream and further data connected with the production of an isolated image and/or Pepper's Ghost to a remote location, apparatus at the remote location for generating an isolated image and/or Pepper Ghost image using the transmitted video stream and switching means for assigning bandwidth of the communication line for the transmission of the video signal when the bandwidth is not used for transmission of the further data.

An advantage of the system of the fifth aspect of the invention is that it concentrates the bandwidth available to achieve a more realistic isolated image and/or Pepper's Ghost. For example, the further data may be data, such as an audio stream, required for interaction between the subject being filmed with persons, such as an audience, etc, at the remote location and the amount of further data that needs to be transmitted may change with changes in the level of interaction.

According to a sixth aspect of the invention there is provided a video processer comprising a video input for receiving a video stream, a video output for transmitting the processed video stream, wherein the processor is arranged to identify an outline of a subject in each frame of the video stream by scanning pixels of each frame to identify pixels or sets of pixels that have a contrast above a predetermined level and defining the outline as a continuous line between these pixels or sets of pixels, and make pixels that fall outside the outline a preselected colour, preferably black.

The video processor of the sixth aspect of the invention may be advantageous as it can automatically key out the subject in each frame of the video stream whilst eliminating noise artefacts outside the outline of the subject. The video processor may be arranged to process the video stream in substantially real time such that the video stream can be transmitted (or at least displayed) in a continuous manner.

Identifying the outline may comprise determining a preset number of consecutive pixels that have an attribute (e.g. brightness and/or colour) that contrasts the attribute of an adjacent preset number of consecutive pixels. By setting the preset number of pixels to an appropriate threshold, the processor does not mistakenly identify sporadic noise as the outline of the subject (the number of pixel artefacts generated by noise is much less than the number of pixels generated by even small objects of the subject). In one embodiment, the video processor has means for adjusting the preset number (i.e. adjusting the threshold at which contrasting pixels are deemed to be caused by the presence of the subject rather than a noise artefact).

The processor may be arranged to modify the frame to provide a line of pixels with high relative luminescence along the identified outline. Each pixel of high relative luminescence may have the same colour as the corresponding pixel which it replaced. The application of high luminescence pixels may enhance the realism of the isolated subject image and/or Pepper's Ghost created by the processed video stream as a bright rim of light around the subject may help to create the illusion that the image is a 3-D rather than 2-D image. Furthermore, by using the same colour for the high luminescence pixels the application of the high luminescence pixels does not render the image unrealistic.

In one arrangement, identifying the outline of the subject comprises lowering a colour bit depth of the frame to produce a lowered colour bit depth frame, scanning the lowered colour bit depth frame to identify an area of the frame containing pixels or sets of pixels that have a contrast above the predetermined level, scanning pixels within a corresponding area of the original frame (that has not had its colour bit depth lowered) to identify pixels or sets of pixels that have a contrast above the predetermined level and defining the outline as a continuous line between these pixels or sets of pixels.

This arrangement is advantageous as the scan can initially be carried out at a lower granularity on the lowered colour bit depth frame and only the identified area of the original frame needs to be scanned at a high granularity. In this way, identification of the outline may be carried out more quickly.

According to a seventh aspect of the invention there is provided a data carrier having stored thereon instructions, which, when executed by a processor, cause the processor to receive a video stream, identify an outline of a subject in each frame of the video stream by scanning pixels of each frame to identify pixels or sets of pixels that have a contrast above a predetermined level and defining the outline as a continuous line between these pixels or sets of pixels, make pixels that fall outside the outline a preselected colour, preferably black, and transmit the processed video stream.

The video processor may be part of the codec according to the first aspect of the invention, the video processor processing the video stream before encoding of the video stream, or alternatively, may be located upstream of the codec that encodes the video stream. The isolating/keying out of the subject from the background may allow further enhancement techniques to be used as part of the encoding process of the codec.

According to an eighth aspect of the invention there is provided a video processor comprising a video input for receiving a video stream, a video output for transmitting the processed video stream, wherein the processor is arranged to identify an outline of a subject in each frame of the video stream by scanning pixels of each frame to identify pixels, or sets of pixels that have a contrast above a predetermined level due to the dark background compared to the bright subject and modifying one or both of these pixels or sets of pixels to have a higher luminescence than an original luminescence of either pixel or set of pixels.

According to a ninth aspect of the invention there is provided a data carrier having stored thereon instructions, which, when executed by a processor, cause the processor to receive a video stream, identifying an outline of a subject in each frame of the video stream by scanning pixels of each frame to identify pixels or sets of pixels that have a contrast above a predetermined level due to the dark background compared to the bright subject and modifying one or both of these pixels or sets of pixels to have a higher luminescence than an original luminescence of either pixel or set of pixels.

According to a tenth aspect of the invention there is provided a codec comprising a video input for receiving a video stream of a subject, an encoder for encoding the video stream to result in an encoded video stream and a video output for transmitting the encoded video stream, the encoder arranged to process each frame of the video stream by identifying an outline of the subject, such as in the manner of the sixth aspect of the invention, and encoding the pixels that fall within the outline whilst disregarding pixels that fall outside the outline to form the encoded video stream.

The tenth aspect of the invention may be advantageous as by only encoding the subject and disregarding the remainder of each frame, the size of the encoded video signal may be reduced. This may help to reduce the bandwidth required and signal latency during transmission.

The pixels that fall outside the outline may be disregarded by filtering out pixels having a specified colour or colour range, for example black or a range black to grey, or pixels having luminescence below a specified level. Alternatively, the pixels that fall outside the outline may be identified from high luminescence pixels that define the outline of the subject and pixels to one side (outside) of this outline of high luminescence pixels are disregarded. Using high luminescence pixels as a guide to remove the unwanted background may be advantageous as dark and/or low luminescence pixels present in the subject may be retained, avoiding unnecessary softening of these parts of the subject.

The encoder may comprise a multiplexer for multiplexing the video stream. The pixels that fall within the outline of the subject may be split into a number of segments and each segment transmitted on a separate carrier as a frequency division multiplexed (FDM) signal. This potentially reduces the need for compression, if any, required for the video stream. Frequency division multiplexing will provide further bandwidth allowing the codec to stretch the video stream across the original time-base whilst minimising compression, if any. In this way, signal latency is reduced whilst the information transmitted is increased.

In one embodiment, the encoder may comprise a scalar to scale the size of the image as required based on the available bandwidth. For example, if there is not sufficient bandwidth to carry a 4:4:4 RGB signal, the image may be scaled to reduce a 4:4:4 RGB signal to a 4:2:2 YUV signal. This may be required in order to reduce signal latency such that, for example, a “Questions and Answer” session could occur between the subject of the isolated subject and/or Pepper's Ghost and a person at the location that the isolated subject and/or Pepper's Ghost is displayed.

Adjusting the encoding format, such as compression, frame-rate, etc, in almost every circumstance will affect the level of signal latency. For preset codecs, the signal latency can be determined beforehand with appropriate measurements and the video and audio synchronised at the location where the isolated subject and/or Pepper's Ghost is displayed taking into account the signal latency. However, with switchable codecs according to the invention, wherein the encoding format may be changed during transmission of the video stream, changes in signal latency have to be taken into account in order to maintain synchronised audio and video. Furthermore, even for systems comprising preset codecs, the signal latency does vary during and/or between transmissions of video streams, for example because of unpredictable changes in the routing across the network, such as a telecommunication network.

According to an eleventh aspect of the invention there is provided a codec comprising a video input for receiving a video stream and associated audio stream, an encoder for encoding the video and audio streams and a video output for transmitting the encoded video and audio streams to another codec, wherein the codec is arranged to, during transmission of the video and audio streams, periodically transmit to another codec a test signal (a ping), receive an echo response to the test signal from the other codec, determine from the time between sending the test signal and receiving the echo response a signal latency for transmission to the other codec and introduce a suitable delay to the or a further audio stream for the determined signal latency.

According to a twelfth aspect of the invention there is provided a codec comprising a video input for receiving from another codec an encoded video stream and associated audio stream, a decoder for decoding the video and audio streams and a video output for transmitting the decoded video and audio streams, wherein the codec is arranged to, during transmission of the video and audio streams, transmit an echo response to the other codec in response to receiving a test signal (a ping).

In this way, the codecs can compensate for changes in the signal latency caused by transmission between the two codecs, maintaining echo cancellation and/or synchronisation of the video and audio streams. A fixed time delay for the rest of a system (i.e. everything excluding the signal latency caused by transmission between the two codecs) may be programmed into the codec according to the eleventh aspect of the invention and the codec may determine the suitable delay to introduce to the audio stream by adding the determined signal latency onto the fixed time delay. For example, further fixed latencies can be introduced as a result of the signal processing and the latency of the audio and display systems at the location at which the isolated subject and/or Pepper's Ghost is displayed and these may be measured before transmission of the video and audio streams and pre-programmed in to the codec.

According to a thirteenth aspect of the invention there is provided a system for transmitting a plurality of video streams to be displayed as an isolated subject and/or Pepper's Ghost comprising a codec for receiving the plurality of video streams, encoding the plurality of video streams and transmitting the encoded plurality of video streams to a remote location, wherein the plurality of video streams are generation locked (Genlocked) based on one of the plurality of video signals.

The system according to the fourteenth aspect of the invention is advantageous as it ensures that the video streams are synchronised when displayed as an isolated image and/or Pepper's Ghost. For example, the system may be part of a communication link wherein multiple parties/subjects at one location are filmed and the resultant plurality of video streams transmitted to another location. In order to ensure that when the video streams are displayed the video streams are synchronised, the video streams are Genlocked by the codec.

It will be understood that each aspect of the invention can be used independently or in combination with other aspects of the invention.

Embodiments of the invention will now be described, by example only, with reference to the accompanying drawings, in which:

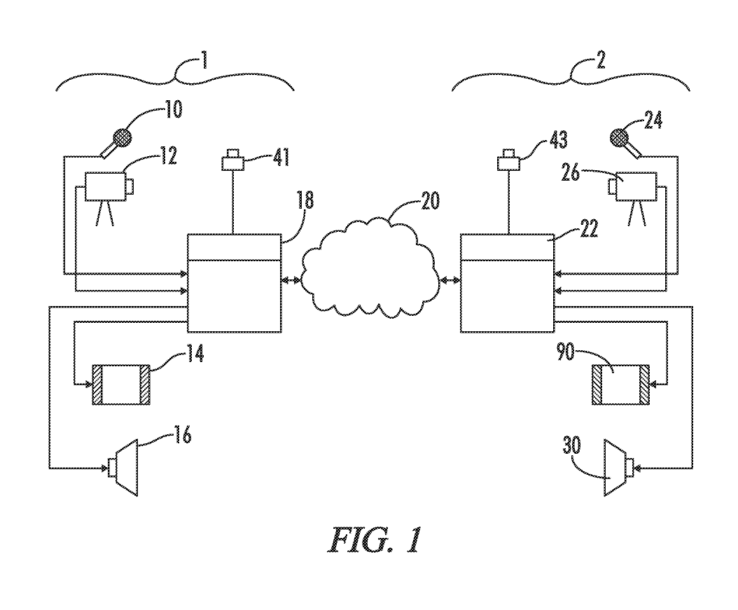

FIG. 1 is a schematic view of a telepresence system according to an embodiment of the invention;

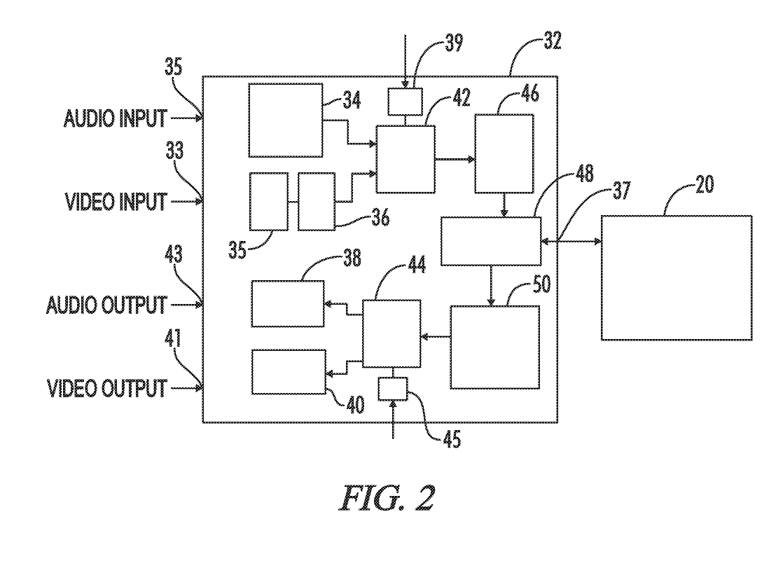

FIG. 2 is a schematic view of a codec according to an embodiment of the invention;

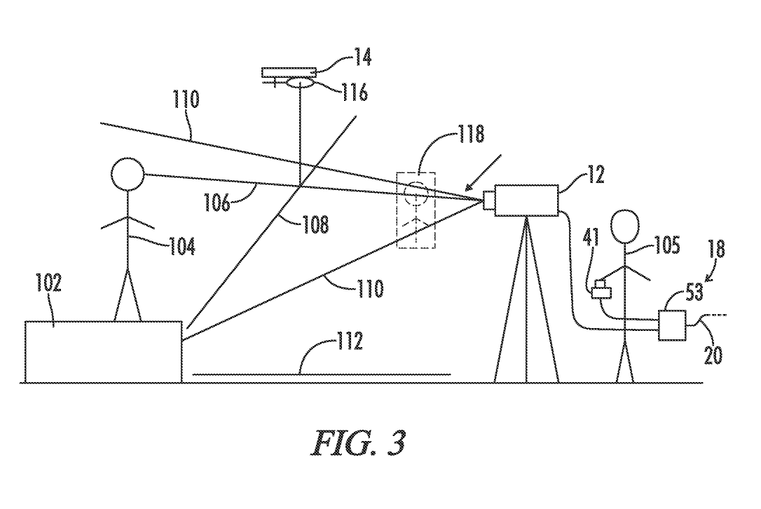

FIG. 3 is a schematic view of a filming setup according to an embodiment of the invention; and

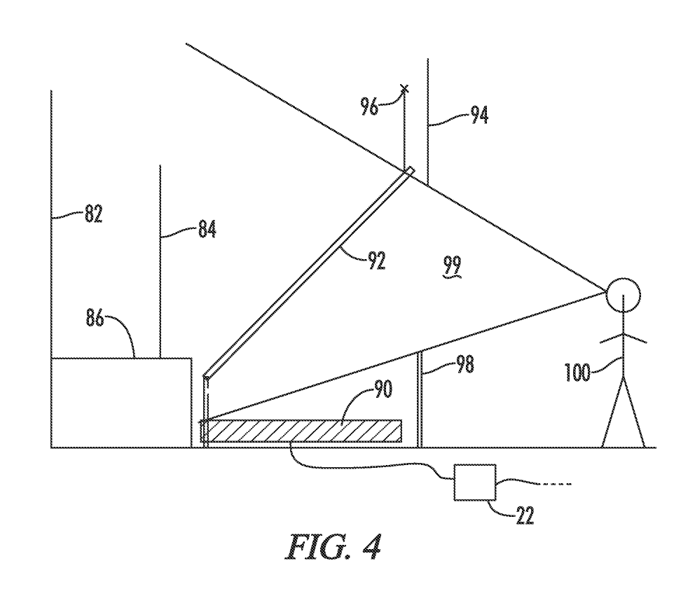

FIG. 4 is a schematic view of apparatus for producing a Pepper's Ghost in accordance with an embodiment of the invention;

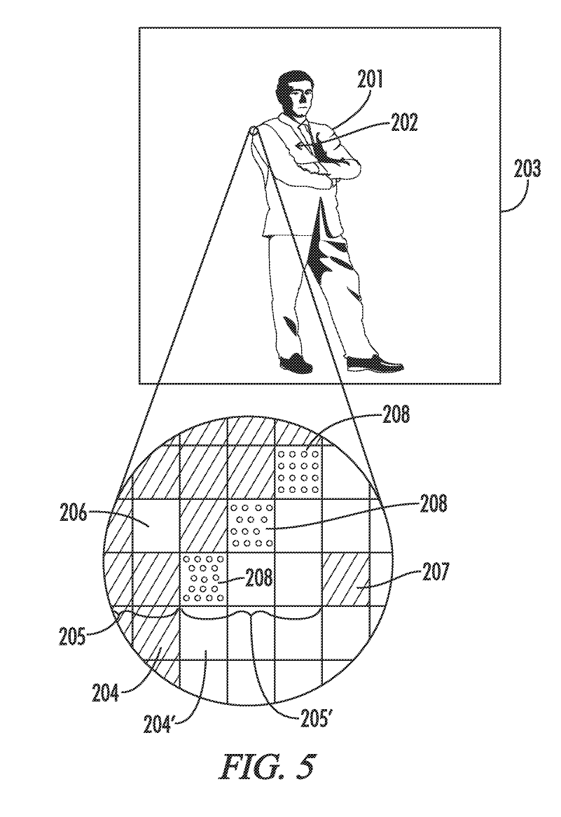

FIG. 5 is a frame of a video image showing schematically the processing of the frame by the codec;

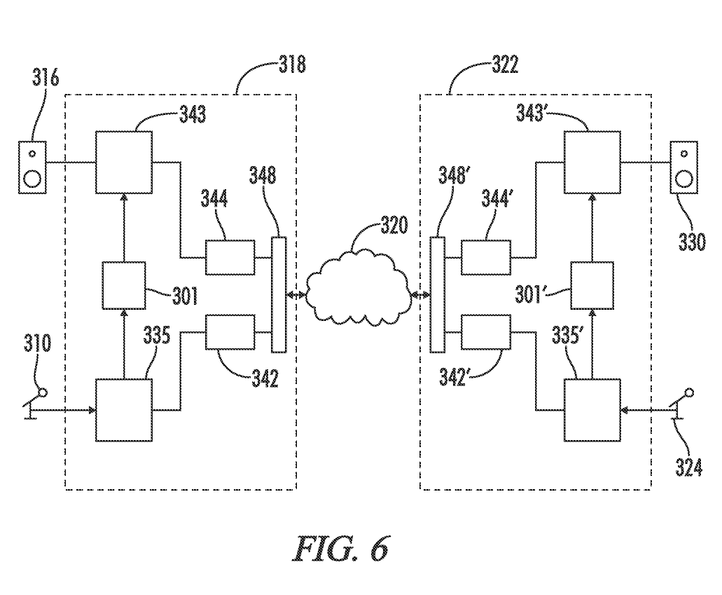

FIG. 6 is a schematic view of audio electronics of a telepresence system according to another embodiment of the invention.

FIG. 1 shows a telepresence system according to an embodiment of the invention comprising a first location 1, at which a subject to be displayed as a Pepper's Ghost is filmed, and a second location 2 remote from the first location 1, at which a Pepper's Ghost of the subject is produced. Data is communicated between the first location 1 and the second location 2 over a bi-directional communication link 20, for example the Internet or a MPLS network, both of which may use a virtual private network or the like.

Referring now to FIGS. 1 and 3, the first location 1 which may be a filming studio, comprises a camera 12 for capturing a subject 104, such as a performer or participant in a meeting, to be projected as a Pepper's Ghost at location 2. In an interactive system where the subject 104 is to interact with person(s) at the second location 2, the first location may comprise a semi-transparent screen 108, for example a foil as described in WO2005096095 or WO2007052005, and a heads up display 14 for projecting an image towards the semi-transparent screen 108 such that the subject 104 can see a reflection 118 of the projected image in the semi-transparent screen 108. A floor of the studio is covered with black material 112 to prevent glare/flare being produced in the camera lens as a result of the presence of the semi-transparent screen 108.

The camera 12 comprises a wide angle zoom lens with adjustable shutter speed; frame rates adjustable between 25 to 120 frames per second (fps) interlaced; and capable of shooting at up to 60 fps progressive.

The raw data video stream generated by the camera 12 is fed into an input 53 of a first codec 18. The codec 18 may be integral with or separate from the camera 12. In another embodiment, the camera may output a progressive, interlaced or other preformatted video stream to the first codec 18.

The first codec 18 encodes the video stream, as described below with reference to FIG. 2, and transmits the encoded video stream over the communication link 20 to the second location 2.

Now referring to FIGS. 1 and 4, the second location 2 comprises a second codec 22 that receives the encoded video stream and decodes the video stream for display as a Pepper's Ghost 84 using the apparatus shown in FIG. 4.

The apparatus comprises a projector 90 that receives the decoded video stream output by the second codec 22 and projects an image based on the decoded video stream towards semi-transparent screen 92 supported between a leg 88 and rigging point 96. Preferably, the projector 90 is a 1080 HD, capable of processing both progressive and interlaced video streams. The semi-transparent screen 92 is a foil screen as described in WO2005096095 and/or WO2007052005.

An audience member 100 viewing the semi-transparent screen 92 perceives an image 84 reflected by the semi-transparent screen on stage 86. The audience 100 views the image 84 through a front mask 94 and 98. A black drape 82 is provided at the rear of the stage 86 to provide a backdrop to the projected image. Corresponding sound is produced via speaker 30.

In one embodiment, location 2 may further comprise a camera 26 for filming audience members 100 or action on stage 86 and a microphone 24 for recording sound at location 2. The camera is capable of processing both progressive and interlaced video streams. Video streams generated by camera 26 and audio streams generated by microphone 24 are fed into codec 22 for transmission to location 1.

The video transmitted to location 1 is decoded by the first codec 18 and heads-up display 14 projects an image based on the decoded video such that the image 118 reflected in screen 108 can be viewed by subject 104. The transmitted audio is played through speaker 16.

In this embodiment, codec 18 and 22 are identical, however it will be understood that in another embodiment, the codecs 18 and 22 may be different. For example, if location 2 does not comprise a camera 26 and microphone 24 for feeding video and audio streams to location 1, the codec 22 may simply be a decoder for receiving video and audio streams and codec 18 may simply be an encoder for encoding the video and audio streams.

The first and second codecs 18 and 22 are in accordance with the codec 32 shown in FIG. 2. Codec 32 has a video input 33 for receiving the continuous video stream captured by the camera 12 or 26 and an audio input 35 for receiving an audio stream recorded by microphone 10 or 24. The received video stream is fed through filter and time base corrector 53, the filtered and time base corrected video signal being fed into a video processor, in this embodiment optical sharpness enhancer (OSE) 36. In this embodiment, the OSE 36 is shown as part of the codec 32 but it will be understood that in another embodiment the OSE 36 may be separate from the codec 32.

Referring to FIG. 5, the (OSE) is arranged to identify an outline 201 of a subject 202 in each frame of the video stream by scanning pixels of each frame 203 of the video stream to identify pixels 204, 204′ or sets of pixels 205 (only part of which is shown), 205′ that have a contrast above a predetermined level and defining the outline as a continuous line between these pixels 204, 204′ or sets of pixels 205. 205′. In FIG. 5 low luminescence pixels 204 and set of pixels 205 are shown by hatched lines, high luminescence pixels shown blank and by a series of dots.

It will be understood that the exact brightness of low and high luminescence pixels will vary from pixel to pixel and the hatched and blank pixels are intended to represent a range of possible low and high luminescence.

The contrast may be a determined by taking a difference between the luminescence of adjacent pixels 204,204′ or adjacent sets of pixels 205, 205′ and dividing by the average luminescence of all pixels of the frame 203. If the contrast between pixels 204, 204′ or sets of pixels 205. 205′ is above a predetermined level then it is determined that these pixels constitute the outline of a subject in the frame. In typical systems for producing isolated subject images or Pepper's Ghosts, the subject is filmed in front of a dark, usually black backdrop, such that the background around the subject is dark, thus producing an image wherein low luminescence pixels 204 represent the background. Furthermore, the subject is usually back lit by rear and side lights that produce a rim of light around the edge of the subject and therefore, pixels of high luminescence around the subject that contrast the pixels of low luminescence that represent the background.

By scanning across the frame 203, the OSE 36 is able to pick up the first instance if high contrast (contrast above the predetermined level) and assuming that the predetermined level is correctly set, this should be the border between pixels of low luminescence showing the background and pixels of high luminescence showing the rim lighting.

The scanning process can be carried out in any suitable manner. For example, the scanning process could scan each pixel beginning from a single side and continue horizontally, vertically or diagonally or could simultaneously scan from opposite sides. If, in the former case, the scan runs across the entire frame 203 or, in the latter case, the two scans meet in the middle without detecting a high contrast between pixels or sets of pixels, the OSE 36 determines that the subject is not present along that line.

Identifying an outline may comprise comparing adjacent pixels 204, 204′ to determine whether the pixels have a contrast above the predetermined level or may comprise comparing adjacent sets of pixels 205, 205′ to determine whether the sets of pixels 205, 205′ have a contrast above the predetermined level. The advantage of the latter case is that it may prevent the OSE 36 from identifying noise artefacts as the outline of the subject. For example, noise may be introduced into the frame 203 by the electronic transmission and processing of the video stream that may result in random pixels 206 and 207 of high or low luminescence in the frame 203. By comparing the luminescence of sets of pixels 205, 205′ rather than the luminescence of individual pixels 204, 204′ the OSE 36 may be able to distinguish between noise and the outline of the subject.

In this embodiment, the preset number corresponding to a set of pixels is three consecutive pixels but a set of pixels may comprise other numbers of pixels such as 4, 5 or 6 pixels. Accordingly, by setting the preset number of pixels to an appropriate threshold, the processor does not mistakenly identify sporadic noise as the outline of the subject (the number of pixel artefacts generated by noise is much less than the number of pixels generated by even small objects of the subject).

In one embodiment, the codec 32/OSE 36 may have means for adjusting the preset number of pixels that form a set of pixels. For example, the codec 32/OSE 36 may have a user input that allows the user to select the number of pixels that form a set of pixels. This may be desirable as the user may be set the granularity in which the scans search for the outline of the subject based on the amount of noise the user believes may have been introduced into the video stream.

The OSE 36 may compare sets of pixels 205, 205′ by summing up the luminescence of all of the pixels that form the set, finding the difference between the sums of the luminescence for the two sets of pixels and dividing the difference by the average pixel luminescence for the frame 203. If the resultant value is above a predetermined value it is determined that a border between the sets of pixels constitutes an outline of the subject. Each pixel may form part of more than one set of pixels, for example the scan may first compare the contrast between the first, second and third pixels of a line to the fourth, fifth and sixth pixels and then compare the contrast of the second, third and fourth pixels of the line to the fifth, sixth and seventh pixels. In this example, the second and third pixels form part of two different sets and fifth and sixth pixels form part of two different sets.

Once the OSE 36 has identified an outline of the subject, the OSE 36 modifies the frame to provide a line of pixels (shown by dotted pixels 208) with high relative luminescence along the identified outline. For example, the dotted pixels may have a luminescence that is higher than any other pixel in the frame 203. In the frame shown in FIG. 5, three of the pixels of the outline have been modified to be high relative luminescence pixels and other pixels, such as 204′, of the outline are yet to be changed. Each pixel 208 of high relative luminescence may have the same colour as the corresponding pixel which it replaced. The application of high luminescence pixels 208 may enhance the realism of the Pepper's Ghost created by the processed video stream as a bright rim of light around the subject may help to create the illusion that the image is a 3-D rather than 2-D image. Furthermore, by using the same colour for the high luminescence pixels 208, the application of the high luminescence pixels 208 does not render the image unrealistic.

The OSE 36 further makes the low luminescence pixels that fall outside the outline black, or another preselected colour as appropriate for display (typically the same colour as the backdrop/drape 82).

In one embodiment, the OSE 36 may carry out two scans of the frame, one when the colour bit depth of the frame is lowered, which reduces the granularity in the contrast but allows the scan to move quickly to identify an area where the edge of the subject may be and a second on the frame at the full colour bit depth bit only in the area (for example tens of pixels wide/high) around the position where the edge was identified in the lowered colour bit depth frame. Such a process may speed up the time it takes to find the edge of the subject.

Referring to FIG. 2, the processed video stream is outputted from the OSE 36 to the encoder 42. The encoder 42 is arranged to encode the received video stream into a selected encoding format, such as a progressive video signal, 720p, 1080p, or interlaced video signal, 1080i, and/or compress the video signal, for example provide variable bit rate between no compression and compression of the video signal to of the order to 1.5 Mb/s.

The audio signal is also fed into encoder 42 and encoded into an appropriate format.

The encoding may comprise encoding the pixels that fall within the outline whilst disregarding pixels that fall outside the outline to form the encoded video stream. The pixels that fall within the outline may be identified from the high luminescence pixels 208 inserted by the OSE 36.

The encoded video stream and encoded audio stream are fed into a multiplexer 46 and the multiplexed signal is output via signal feed connection 48 to a bi-directional communication link 20 via input/output 37.

In this embodiment, the pixels that fall within the outline of the subject are split into a number of segments, and each segment transmitted on a separate carrier as a frequency division multiplexed (FDM) signal. Frequency division multiplexing will provide further bandwidth allowing the codec to stretch the signal across the original time-base whilst minimising compression, if any. In this way, signal latency is reduced whilst the information transmitted is increased.

The codec 32 further comprises switching means 39 arranged to switch the encoder 42 between a plurality of modes in which the video signal is encoded in accordance with a different encoding format. The switching means 39 and encoder 42 are arranged such that a switch between modes can occur during transmission of a continuous video stream, i.e. the switch occurs without disrupting the transmission of the video stream in such a way as to prevent the video being projected continuously (in real-time) at location 2 or 1 to produce a Pepper's Ghost. The switching means 39 causes the encoder 42 to switch modes in response to a control signal received, in this embodiment, from a user activated switch 41 or 43.

The codec 32 also receives encoded video and audio stream from the bi-directional link 20 and the feed connection 48 directs the received signal to demultiplexer 50. The video and audio streams are demultiplexed and the demultiplexed signals are fed into decoder 44.

The decoder 44 is arranged to decode the received video stream from a selected encoding format, such as a progressive video signal, 720p, 1080p, or interlaced video signal, 1080i, and/or decompress the video signal to result in a video stream suitable for display.

The decoded video stream is fed into time base corrector 40 and output to display 90 or 20 via output 41. The decoded audio stream is fed into an equaliser 38 that corrects signal spread and outputs the audio stream to speaker 30 or 16 via output 43.

Switching means 45 is arranged to switch the decoder 44 between a plurality of modes in which the video signal is decoded in accordance with a different encoding format. The switching means 45 and decoder 44 are arranged such that a switch between modes can occur during transmission of a continuous video stream, i.e. the switch occurs without disrupting the transmission of the video stream in such a way as to prevent the video being projected continuously (in real-time) at location 1 or 2. The switching means 45 causes the decoder 45 to switch modes in response to a control signal received, in this embodiment, from a user activated switch 43 or 41. In this embodiment, the switching means 45 of codec 18 is responsive to user activated switch 43 and the switching means 45 of codec 22 is responsive to user activated switch 43.

The encoder 42 and decoder 44 may also be capable of converting the video image from one size or resolution to another, as required by the system. This allows the system to adapt the video image as required for projection and/or transmission. For example, the video image may be projected as a window within a larger image and therefore, needs to be reduced in size and/or resolution. Alternatively or additionally, the video image may be scaled based on the available bandwidth. For example, if there is not sufficient bandwidth to carry a 4:4:4 signal, the image may be scaled to reduce a 4:4:4 RGB signal to a 4:2:2 YUV signal. This may be required in order to reduce signal latency such that, for example, a “Questions and Answer” session could occur between the subject of the Pepper's Ghost and a person at the location that the Pepper's Ghost is displayed. Having a codec with an integral scalar means the use of a separate video scalar is not necessary, reducing the need for another level of hardware that may increase complexity of the system.

The codec 32 is arranged to apply a delay to the audio stream in order to ensure that the video and audio streams are displayed/sounded synchronously at the location that they are sent and to provide echo cancellation. In one embodiment, the delay applied to the audio signal is a variable delay determined based on a signal latency measured during transmission of the video and audio signals. FIG. 6 illustrates a codec setup that can achieve such an audio delay. In the codec setup shown in FIG. 6, an audio delay module/audio cancellation module 301, 301′ is located between the audio input 335, 335′ and the audio output 343, 343′ and the variable delay applied to the audio output is based on the method described below.

The codec 32 is programmed with a fixed time delay and during transmission of the video and audio streams the codec 318 or 322 periodically transmits to the other codec 322 or 318 a test signal (a ping). In response to receiving a test signal, the other codec 322 or 318 sends an echo response to codec 318, 322. From the time between sending the test signal and receiving the echo response codec 318, 322 can determine a signal latency for transmission. The instantaneous total time delay is determined by adding on the signal latency to the fixed delay and this total time delay is introduced to the audio stream.

The pre-programmed fixed time delay is used to take account of delays in the transmission of the audio signal from other sources other than the transmission between the codecs 318, 322. For example, delays may be caused by signal latency caused by processing of the video streams and latency in the speakers 316, 330 for outputting the transmitted audio. The fixed time delay may be determined before transmission of the audio and video streams by setting all microphones 310, 324 and speakers 316, 330 to a reference level and then sending a 1 KHz pulse (for example having a few ones or tens of millisecond duration) at a fixed decibel level, for example −18 dB FS to the input of a codec 318, 322 and measuring a time it takes for the pulse to be transmitted from the codec's output, the pulse having been transmitted to the other codec 322, 318 across the audio system, for example, from speaker 318, 330 to the microphone 310, 324 connected with the other codec 322, 318, back to the input of the other codec 322, 318 and back to the first codec 318, 322. This will give the total delay in the system for the transmission of the pulse. The signal latency along the transmission line 320 is then measured as described above and the determined signal latency is subtracted from the measured total delay. This gives a fixed time delay for the audio resulting from sources other than the transmission between the two codecs 318, 322.

As described above, during transmission of the video and audio streams, the measured signal latency (variable time delay) can be added to the fixed time delay to give the instantaneous total time delay in the system and this determined instantaneous time delay is used for echo cancellation.

Echo cancellation is achieved by dividing the audio stream fed into the input to the codec 318, 322 and feeding one of the divided audio streams into the echo cancellation module 301, 301′. The echo cancellation module 318, 322 also receives the instantaneous total fixed time delay determined by the codec 318, 322. The echo cancellation module 318, 322 delays the audio stream that it receives and phase-inverts the audio stream. This delayed phase-inverted audio stream is then superimposed on the output audio stream to (at least partially) cancel echo of the input audio stream present in the output audio stream.

In one embodiment, a plurality of video and audio streams may be transmitted between the codecs 18, 22, 318, 322. For example, at the second location 2 both a person (not shown), such as a presenter, on stage 86 and one or more audience members 100 may be filmed and video and audio streams associated with this video capture are transmitted via the codecs 318, 322 to location 1 where the video stream is displayed as an isolated subject image and/or Pepper's Ghost. In order to ensure that display of the plurality of video streams is synchronised, the plurality of video streams are generation locked (Genlocked) based on one of the plurality of video signals, for example the video stream of the person on stage.

In one embodiment, the system allows the subject 104 being filmed at the first location 1 to view a number of different video feeds from the second location 2 including one or more of the person on stage 86 as filmed from a fixed camera in front of the stage, a person on stage 86 as filmed from a camera giving the audience perspective (including a Pepper's Ghost of the subject), a camera giving a stage hand's perspective and one or more of the audience members 100. The subject may have the option of selecting which video stream to view and or to alter what is being filmed in each video stream. Accordingly, the subject may be able to do a virtual fly through of the second location 2 being able to view a number of different elements of the second location that have been/are captured by one or more cameras. This may be implemented by a touch screen interface (not shown) available to the subject 104. The interface that allows the subject 104 to interact with the codec 18, 22, 318, 322 may comprise a sight/view perspective of the venue, it may be venues upon a map displaying a multi-point broadcast or it may be a directory of other participants that the subject 104 may select to view the full video stream.

In a system in which multiple video streams are to be transmitted, a codec box may be provided comprising a plurality of separate removable codec modules 32 (blades) for each video stream to be transmitted. For example, location 2 may comprise two video cameras, one for filming the action on stage 86 and another for filming audience members 100 and both video streams may be transmitted to location 1 for projection on the heads-up display. For this, separate codecs 32 may be required, one for each video stream.

In use, a subject 104 is filmed by camera 12 and the generated video stream is fed into the first codec 18 under the control of an operator, for example a producer, 105. The first codec 18 encodes the video signal in accordance with a selected format and transmits the encoded video stream to codec 22. Codec 22 decodes the video stream and feeds the decoded video stream to projector 90 that projects an image based on the video stream to produce a Pepper's Ghost 84.

The controller 105 observes the subject 104 during filming and if the observer deems that certain requirements, such as increased movement of the subject 104 or the display of text or graphics is occurring/will occur in the near future, the controller 105 operates switch 41 to cause codecs 18 and 22 to switch mode to use a different encoding format. For example, the controller 105 may select a progressive encoding format when text or graphics are displayed, a highly compressed interlaced encoding format when there is significant movement of the subject 104 or an uncompressed interlaced or progressive encoding format when the footage/subject being filmed comprises many small, intricate details that do not want to be lost through compression of the video stream. In one embodiment, the switch is a menu on a computer screen that allows the controller 105 to select the desired encoding format.

In one embodiment, the system also comprises camera 24 that records members of the audience or other person at location 2 for display on heads-up display 14/118. In the same manner as the video stream is being transmitted to location 2 from location 1, a controller 2 may operate switch 43 to switch codec 22 to encode the video stream being transmitted from location 2 to location 1 using a different format and to switch codec 18 to decode the video stream using the different format based on the footage being filmed by camera 26.

In another embodiment, the operators or other persons at each location may communicate with each other to provide feedback on any deterioration in the quality of the image 84 or 118 and the operator may cause the codec 18, 22 to switch the encoding format based on the feedback.

In another embodiment, the system comprises means for detecting the bandwidth available, which automatically generates the control signal to switch the codecs to a different mode as appropriate for the available bandwidth. For example, if the measured signal latency rises above a predetermined level, the encoding format may be switched from progressive to interlaced or to a higher compression rate.

In another embodiment, the codecs 18 and 22 are arranged to allocate bandwidth to different data streams, such as the video data stream, audio data stream and a control data stream, wherein if the codec 18, 22 identifies a reduction in the audio data stream or control data stream it reallocates this available bandwidth to the video stream.

In one embodiment, the codecs 18 and 22 may be arranged to automatically determine an encoding format of a received encoded video stream and switch to decode the encoded video stream using the correct decoding format.

It will be understood that the codecs 18 and 20 may be embodied in software or hardware.

It will be understood that alterations and modifications may be made to the invention without departing from the scope of the claims.

1. A codec, comprising:
a video input for receiving a continuous video stream;
an encoder for encoding the continuous video stream to result in an encoded video stream;
a video output for transmitting the encoded video stream; and
switching means for switching the encoder during encoding between a first mode, in which the continuous video stream is encoded in accordance with a first encoding format, to a second mode, in which the continuous video stream is encoded in accordance with a second encoding format.

2. A codec, comprising:
a video input for receiving an encoded video stream;
a decoder for decoding the encoded video stream to result in a decoded video stream;
a video output for transmitting the decoded video stream; and
switching means for switching the decoder during decoding between a first mode, in which the encoded video stream is decoded in accordance with a first encoding format, to a second mode, in which the encoded video stream is decoded in accordance with a second encoding format.

3. The codec of claim 1, wherein the switching means is responsive to an external control signal for switching the encoder between the first mode and the second mode.

4. The codec of claim 1, wherein the codec is capable of changing resolution and/or size of a video image of the continuous video stream.

5. A telepresence system, comprising:
a camera for filming a subject to be displayed as an isolated subject image and/or Pepper's Ghost;
a first codec for receiving a video stream generated by the camera and outputting an encoded video stream, the first codec including a first video input for receiving the video stream, an encoder for encoding the video stream to result in the encoded video stream, a first video output for transmitting the encoded video stream, and switching means for switching the encoder during encoding between a first encoding mode, in which the video stream is encoded in accordance with a first encoding format, to a second encoding mode, in which the video stream is encoded in accordance with a second encoding format;
means for transmitting the encoded video stream to a second codec at a remote location, the second codec including a second video input for receiving the encoded video stream, a decoder for decoding the encoded video stream to result in a decoded video stream, a second video output for transmitting the decoded video stream, and switching means for switching the decoder during decoding between a first decoding mode, in which the encoded video stream is decoded in accordance with the first encoding format, to a second decoding mode, in which the encoded video stream is decoded in accordance with the second encoding format, the second codec arranged to decode the encoded video stream and output the decoded video stream to apparatus for producing the isolated subject image and/or Pepper's Ghost based on the decoded video stream; and
a user operated switch arranged to generate a control signal to cause the first codec to switch between the first encoding mode and the second encoding mode.

6. The telepresence system of claim 5, wherein the user operated switch is further arranged to generate a control signal to cause the second codec to switch between the first decoding mode and the second decoding mode.

7. The telepresence system of claim 6, wherein the second codec is arranged to automatically determine an encoding format of the encoded video stream and switch to decode the encoded video stream using a decoding mode corresponding to the encoding format.

8. A method of generating a telepresence of a subject, comprising:
filming the subject to generate a continuous video stream;
transmitting the continuous video stream to a remote location to generate a transmitted video stream; and
producing an isolated subject image and/or Pepper's Ghost at the remote location based on the transmitted video stream;
wherein transmitting the continuous video stream comprises selecting different ones of a plurality of encoding formats during transmission of the continuous video stream based on changes in action being filmed and changing encoding format to selected encoding formats during transmission.

9. The method of claim 8, wherein the changes in action are changes in amount of movement of the subject, changes in lighting of the subject, changes in level of interaction of the subject with a person at the remote location, and/or inclusion of text or graphics in an image to be displayed.

10. A video processer, comprising:
a video input for receiving a video stream;
a video output for transmitting processed video stream;
wherein the video processor is arranged to identify an outline of a subject in each frame of the video stream by scanning pixels of each frame to identify pixels or sets of pixels that have a contrast above a predetermined level and defining the outline of the subject as a continuous line between the pixels or sets of pixels, and make pixels that fall outside the outline of the subject a preselected colour.

11. The video processor of claim 10, wherein the video processor is arranged to process the video stream in substantially real time such that the video stream can be transmitted or displayed in a continuous manner.

12. The video processor of claim 10, wherein identifying the outline of the subject comprises determining a preset number of consecutive pixels that have a first attribute that contrasts a second attribute of an adjacent preset number of consecutive pixels.

13. The video processor of claim 12, comprising means for adjusting the preset number.

14. The video processor of claim 10, wherein the video processor is arranged to modify a frame to provide a line of pixels with high relative luminescence along the outline of the subject.

15. The video processor of claim 14, wherein each pixel of high relative luminescence replaces a corresponding pixel having an original colour and has a colour that is the same as the original colour.

16. A data carrier having stored thereon instructions, which, when executed by a processor, cause the processor to receive a video stream; process the video stream to generate a processed video stream by identifying an outline of a subject in each frame of the video stream by scanning pixels of each frame to identify pixels or sets of pixels that have a contrast above a predetermined level, defining the outline of the subject as a continuous line between the pixels or sets of pixels, and making pixels that fall outside the outline of the subject a preselected colour; and to transmit the processed video stream.

17. A codec, comprising:
a video input for receiving a video stream of a subject;
an encoder for encoding the video stream to result in an encoded video stream; and
a video output for transmitting the encoded video stream;
wherein the encoder is arranged to process each frame of the video stream by identifying an outline of the subject and encoding pixels that fall within the outline of the subject while disregarding pixels that fall outside the outline of the subject to form the encoded video stream.

18. The codec of claim 17, wherein the pixels that fall outside the outline of the subject are identified from high luminescence pixels that define the outline of the subject and pixels outside of the high luminescence pixels are disregarded.

19. The codec of claim 17, wherein the encoder comprises a multiplexer for multiplexing the video stream.

20. The codec of claim 19, wherein pixels that fall within the outline of the subject are split into a number of segments and each segment transmitted on a separate carrier as a frequency division multiplexed (FDM) signal.

21. A codec, comprising:
a video input for receiving a video stream and an associated audio stream;
an encoder for encoding the video and associated audio streams; and
a video output for transmitting the encoded video and associated audio streams to a second codec;
wherein the codec is arranged to, during transmission of the video and associated audio streams, periodically transmit to the second codec a test signal, receive an echo response to the test signal from the second codec, determine from a time between sending the test signal and receiving the echo response a signal latency for transmission to the second codec and introduce a suitable delay to the video and associated audio streams for the signal latency.

22. A codec, comprising:
a video input for receiving from a second codec an encoded video stream and associated audio stream;
a decoder for decoding the encoded video stream and associated audio stream to generate a decoded video stream and associated audio stream; and
a video output for transmitting the decoded video and associated audio streams;
wherein the codec is arranged to, during transmission of the decoded video and associated audio streams, transmit an echo response to the second codec in response to receiving a test signal.

23. A system for transmitting a plurality of video streams to be displayed as an isolated subject and/or Pepper's Ghost, comprising:
a codec for receiving a plurality of video streams, encoding the plurality of video streams to generate a plurality of encoded video streams, and transmitting the plurality of encoded video streams to a remote location;
wherein the plurality of video streams are generation locked based on one of the plurality of video streams.

24. A video processor, comprising:
a video input for receiving a video stream; and
a video output for transmitting a processed video stream;
wherein the video processor is arranged to identify an outline of a subject in each frame of the video stream by scanning each line of pixels of each frame to identify pixels or sets of pixels that have a contrast above a predetermined level due to a dark background compared to a bright subject and modifying the pixels or sets of pixels to have a higher luminescence than an original luminescence of the pixel or set of pixels.

25. A telepresence system, comprising:
a filming system at a first location for filming a subject to be projected as an isolated subject or Pepper's Ghost image and generating a corresponding video stream, the filming system including a codec for encoding the corresponding video stream using one of a plurality of encoding formats to generate an encoded video stream and varying encoding of the corresponding video stream from any one of the plurality of encoding formats to another in response to changes in action being filmed;
a projecting system at a second location for producing the isolated subject or Pepper's Ghost image filmed with the filming system, the projecting system including a second codec for receiving the encoded video stream from the filming system and for decoding the encoded video stream to generate a decoded video stream, the second codec operable to switch to a decoding mode capable of decoding the encoded video stream in response to a control signal received from a user operated switch or in response to the second codec automatically determining which one of the plurality of encoding formats was used to encode the encoded video stream; and
a bi-directional communication link connected to the filming system and the projecting system for communicating data between the first location and the second location.

26. The telepresence system of claim 25, wherein:
the filming system further includes a camera for filming the subject and generating the corresponding video stream, and a microphone for recording sound at the first location and generating a corresponding audio stream;
the first codec is further operable to encode the corresponding audio stream and transmit both the encoded audio and video streams over the bi-directional communication link to the projecting system;
the second codec is further operable to decode the encoded audio stream to generate a decoded audio stream; and
the projecting system further includes a speaker for generating sound based on the decoded audio stream.

27. The telepresence system of claim 26, wherein the projecting system includes:
a projector connected to the second codec for receiving the decoded video stream and projecting an image based on the decoded video stream toward a semi-transparent screen; and
a stage positioned relative to the semi-transparent screen so that an audience member perceives a virtual image reflected by the semi-transparent screen on the stage.

28. The telepresence system of claim 27, wherein:
the projecting system includes a second camera for filming audience members or action on the stage and generating a second corresponding video stream;
a second microphone for recording sound at the second location and generating a second corresponding audio stream;
the second corresponding audio and video streams are fed into the second codec, encoded by the second codec to generate a second encoded audio stream and a second encoded video stream, and transmitted by the second codec to the first location using the bi-directional communication link;
the codec is operable to decode the second encoded audio and video streams to generate a second decoded audio stream and a second decoded video stream;
the filming system further includes a second semi-transparent screen positioned between the camera and the subject;
the filming system further includes a heads up display for projecting a second image based on the second decoded video stream toward the second semi-transparent screen so that the subject perceives a second virtual image reflected by the second semi-transparent screen between the camera and the second semi-transparent screen; and
the filming system includes a second speaker for generating sound based on the second decoded audio stream.

29. The telepresence system of claim 28, wherein:
the filming system further includes black material positioned relative to the camera, subject, and second semi-transparent screen to prevent glare from being produced in the camera by the second semi-transparent screen; and
the subject is a performer or a participant in a meeting.

30. The telepresence system of claim 29, wherein the cameras include wide angle zoom lenses with adjustable shutter speeds, have frame rates adjustable between 25 and 120 frames per second interlaced, and are capable of shooting at up to 60 frames per second progressive.

31. The telepresence system of claim 30, wherein the codecs are integrated with the cameras and the cameras are operable to output progressive, interlaced, or other preformatted video streams.

32. The telepresence system of claim 31, wherein the projector is a 1080 high definition projector and is capable of processing both progressive and interlaced video streams, and the semi-transparent screens are foil screens.

33. The telepresence system of claim 32, wherein:
the audience member views the virtual image through upper and lower front masks positioned adjacent to the semi-transparent screen and a black drape is provided adjacent to the stage to provide a backdrop for the virtual image; and
the second semi-transparent screen is supported between a leg and a rigging point.

34. The telepresence system of claim 33, wherein the bi-directional communication link includes the internet or a virtual private network and the first location is a filming studio.
